(19) United States
(12) Patent Application Publication
(10) Pub. No.: US 2008/0147760 A1
(43) Pub. Date: Jun. 19, 2008

(54) System and method for performing accelerated finite impulse response filtering operations in a microprocessor

(75) Inventor: Timothy Martin Dobson, Cambridge (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Comporation, Irvine, CA (US)

(21) Appl. No.: 11/640,297

(22) Filed: Dec. 18, 2006

(51) Int. Cl. G06F 17/10

(52) U.S. Cl. 708/300

(57) ABSTRACT

A system and method for accelerating the performance of finite impulse response (FIR) filtering operations in a processor system. The system and method accelerates FIR filtering operations by using a holding register to provide additional input samples to an instruction beyond those normally accommodated by source registers, and by using a large number of multipliers that can operate in parallel on the input samples in order to generate output sample of a FIR filter, such as a non-decimating FIR filter.

### FIELD OF THE INVENTION

The present invention relates generally to processor systems, and more specifically, to processor systems that execute instructions for performing finite impulse response (FIR) filtering operations.

### BACKGROUND OF THE INVENTION

A finite impulse response (FIR) filter is a type of digital filter commonly used in digital signal processing (DSP) applications and, in general, in data acquisition and processing applications. If a FIR filter has a large number of filter taps, then a significant number of multiplication and addition operations must be performed to generate a single output sample. Implementing such a filter in a processor system typically requires processing a significant number of instructions (e.g., multiply-accumulate instructions), which adversely impacts processor throughput. The provision of additional structures, such as additional multipliers, to the processor's functional units can assist in accelerating throughput, but only if an increased number of input samples can be provided per instruction.

What is needed is a system and method for accelerating the performance of FIR filtering operations in a processor system that addresses the foregoing issues.

### SUMMARY OF THE INVENTION

The present invention provides a system and method for accelerating the performance of finite impulse response (FIR) filtering operations in a processor system. A system and method in accordance with the present invention accelerates FIR filtering operations by using a holding register to provide additional input samples for processing an instruction beyond those normally accommodated by the instruction's source registers, and by using a large number of multipliers that can operate in parallel on the input samples in order to generate output samples of a FIR filter, such as a non-decimating FIR filter.

In particular, a method for performing finite impulse response (FIR) filtering operations in a processor system in accordance with an embodiment of the present invention includes a number of steps. First, a first plurality of successive input samples is stored in a holding register responsive to the issuance of a first instruction. Then, responsive to the issuance of a second instruction that specifies a second plurality of successive input samples as source operands, calculations are performed based on the first plurality of successive input samples and at least one of the second plurality of input samples to generate one or more output samples of a FIR filter. The FIR filter may be a non-decimating FIR filter. The performance of calculations may include multiplying each of the first plurality of successive input samples by one or more filter coefficients and multiplying at least one of the second plurality of successive input samples by a filter coefficient using different multipliers operating substantially in parallel.

A processor system in accordance with an embodiment of the present invention includes a holding register, an instruction decode unit, and an execution unit connected to the holding register and the instruction decode unit. The execution unit is adapted to store a first plurality of successive input samples in the holding register responsive to issuance of a first instruction from the instruction decode unit. The execution unit is also adapted to perform calculations based on the first plurality of successive input samples stored in the holding register and at least one of a second plurality of input samples to generate one or more output samples of a FIR filter responsive to issuance of a second instruction from the instruction decode unit, wherein the second instruction specifies the second plurality of successive input samples as source operands. The FIR filter may be a non-decimating FIR filter. The execution unit may include a plurality of multipliers, each of which is adapted to multiply each of the first plurality of successive input samples by one or more filter coefficients or to multiply at least one of the second plurality of successive input samples by a filter coefficient. Each of the plurality of multipliers may be adapted to perform a different one of the multiplications substantially in parallel with the others multipliers.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary processor system that may be used to implement the present invention.

FIG. 2 depicts a flowchart of a method for performing non-decimating finite impulse response (FIR) filtering operations in a processor system.

FIG. 3 illustrates multiply-accumulate (MAC) operations performed by a processor system that implements a non-decimating FIR filter.

FIGS. 4A and 4B illustrate holding registers used for implementing a non-decimating FIR filter in a processor system in accordance with an embodiment of the present invention.

FIG. 5 depicts a flowchart of a method for performing non-decimating FIR filtering operations in a processor system in accordance with an embodiment of the present invention.

FIG. 6 depicts a flowchart of operations that occur in a processor responsive to execution of a FIR instruction in accordance with an embodiment of the present invention.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

### 1. Architecture Overview

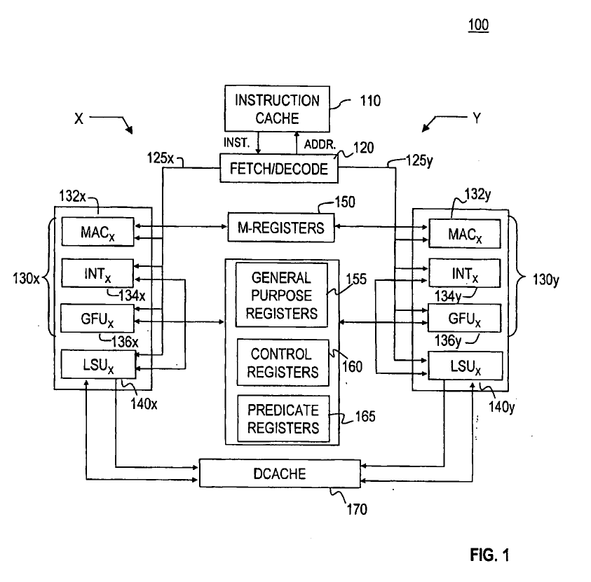

FIG. 1 illustrates an exemplary processor system 100 that may be used to implement the present invention. More details concerning such a processor system can be found in U.S. Pat. No. 6,986,025 to Wilson, issued Jan. 10, 2006, the entirety of which is incorporated by reference herein. Processor system 100 is a 64-bit long instruction word machine including two identical Single Instruction Multiple Data (SIMD) units designated by reference letters X and Y. In a SIMD processor, a single instruction can be issued to control the processing of multiple data values in parallel. Processor system 100 is described herein by way of example only. Persons skilled in the art will readily appreciate that the present invention may be implemented using other processor systems.

Processor system 100 includes an instruction cache 110 for receiving and holding instructions from a program memory (not shown). Instruction cache 110 is coupled to fetch/decode circuitry 120. Fetch/decode circuitry 120 issues addresses in the program memory from which instructions are to be fetched and receives on each fetch operation a 64 bit instruction from cache 110 (or program memory). In addition, fetch/decode circuitry 120 evaluates an opcode in an instruction and transmits control signals along channels 125x, 125y to control the movement of data between designated registers and a number of functional units. The functional units include a Multiplier Accumulator (MAC) 132, an Integer Unit (INT) 134, a Galois Field Unit (GFU) 136, and a Load/Store Unit (LSU) 140.

Processor system 100 includes two SIMD execution units 130x, 130y, one on the X-side of the machine and one on the Y-side of the machine. Each of the SIMD execution units 130x, 130y includes a Multiplier Accumulator Unit (MAC) 132, an Integer Unit (INT) 134, and a Galois Field Unit (GFU) 136. MAC units 132x, 132y perform the process of multiplication and addition of products commonly used in many digital signal processing algorithms. Integer units 134x, 134y perform many common operations on integer values used in general computation and signal processing. Galois field units 136x, 136y perform special operations using Galois field arithmetic such as may be executed in implementations of the Reed-Solomon error protection coding scheme.

In addition, a Load/Store Unit (LSU) 140x, 140y is provided on the X and Y-side SIMD units. Load/store units 140x, 140y perform accesses to a data cache or RAM, either to load data values from the data cache/RAM into a general purpose register 155 or to store values to the data cache/RAM from a general purpose register 155.

Processor system 100 further includes a dual port data cache (DCACHE) 170 coupled to the X-side and Y-side SIMD units and a data memory (not shown). Although FIG. 1 depicts a DCACHE, as would be appreciated by persons of skill in the art, other storage implementations can be used with the present invention.

Processor system 100 includes multiple registers (M-registers) 150 for holding multiply-accumulate results and multiple general purpose registers (GPRs) 155. In an embodiment, processor system 100 includes four M-registers and sixty-four 64-bit GPRs. Processor system 100 also includes multiple control registers 160 and multiple predicate registers 165.

In order to perform SIMD multiplication operations on four 16-bit operands to produce four lanes of output, each MAC unit 132x and 132y would need to include at least four 16-bit multipliers. However, in processor system 100 each MAC unit 132x and 132y can also perform SIMD multiplication operations on two 32-bit operands to produce two lanes of output. In order to support this, each MAC unit 132x and 132y includes eight 16-bit multipliers, wherein four 16-bit multipliers are used to perform a single 32-bit multiply.

### 2. Non-Decimating FIR Filtering Operations in Accordance with an Embodiment of the Present Invention

A non-decimating FIR filter can typically be expressed in the form:

$${output}_{i} = {\sum }_{j = 0}^{L - 1} {input}_{i + j} \cdot {coeff}_{j}$$

where inputᵢ is an input sample, outputᵢ is an output sample, L is the length of the filter, and coeff₀, coeff₁, coeff₂, . . . , coeff_{L-1} are the filter coefficients. Based on the foregoing equation, it can be seen that the necessary operations for producing 8 output samples may be represented as follows:

output₀=input₀·coeff₀+input₁·coeff₂+input₂·coeff₂+input₃·coeff₃+ . . . input_{L-1}·coeff_{L-1},

output₁=input₁·coeff₀+input₂·coeff₁+input₃·coeff₂+input₄·coeff₃+ . . . input_{L}·coeff_{L-1},

output₂=input₂·coeff₀+input₃·coeff₁+input₄·coeff₂+input₅·coeff₃+ . . . input_{L+1}·coeff_{L-1},

output₃=input₃·coeff₀+input₄·coeff₁+input₅·coeff₂+input₆·coeff₃+ . . . input_{L+2}·coeff_{L-1},

. . .

output₁=input₁·coeff₀+input₈·coeff₁+input₉·coeff₂+input₁₀·coeff₃+ . . . input_{L+6}·coeff_{L-1}.

One approach for performing the foregoing operations on a processor system having two SIMD units such as processor system 100 will now be described. For the purposes of this description, it will be assumed that the input and output samples are 16-bit samples, and the filter coefficients are 16-bit signed samples with 15 binary places. However, as will be readily appreciated by persons skilled in the art, other representations of the input and output samples and filter coefficients may be used.

In accordance with this approach, for every eight output samples to be generated, L successive MAC instructions are executed, wherein each MAC instruction causes each of MAC 132x and MAC 132y to multiply four successive input samples by the same respective filter coefficient value. With each successive MAC instruction, the input is shifted by one input sample. Representative programming logic for a loop that performs these operations is as follows:

```
loop:
  MZC2SSH m0/m1, inx0to3/iny4to7, coeff0.h0 : LDL2 inx0to3/iny4to7,
  [input, #0]
  MAC2SSH m0/m1, inx1to4/iny5to8, coeff0.h1 : LDL2 inx1to4/iny5to8,
  [input, #2]
  MAC2SSH m0/m1, inx2to6/iny6to9, coeff0.h2 : LDL2 inx2to5/iny6to9,
  [input, #4]
  . . .
  MAC2SSH m0/m1, inx(L−1)to(L+2)/iny(L+3)to(L+6),
  coeff<m>.h<n> : LDL2 . . .
```

| | |
|---|---|
| MMV2H | out0/out1, m0/m1, shift |
| . . . | |
| STL2 | out0/out1, [output], #16! |
| SBCCL | loop : SUBWBS len, len, #1 |

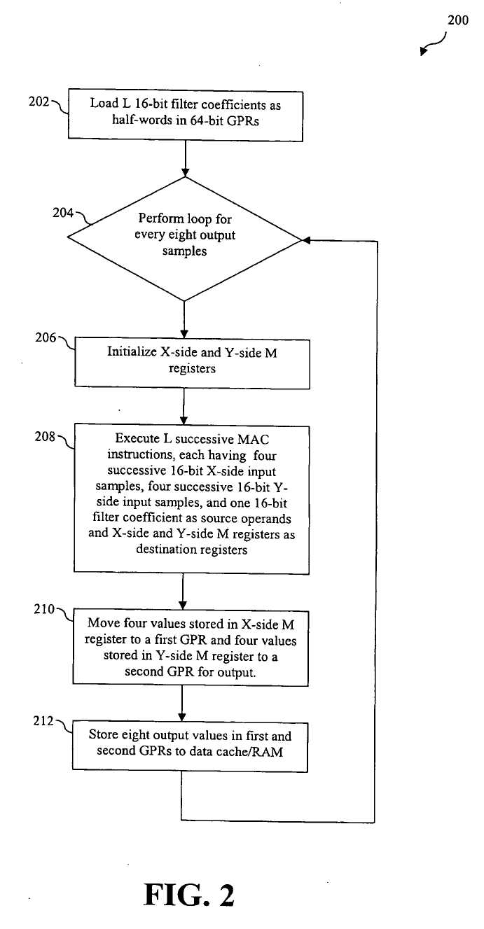

This approach will now be described with reference to flowchart 200 of FIG. 2. As shown in FIG. 2, at step 202, L 16-bit filter coefficients are initially loaded as half-words in GPRs 155, such that four filter coefficients are loaded in a single 64-bit GPR. Thus, for example, four filter coefficients loaded in a register coeff0 may be individually identified as coeff0.h0, coeff0.h1, coeff0.h2 and coeff0.h3.

At step 204, an iteration of a loop in accordance with the foregoing programming logic is performed for every eight output samples to be generated. As will be appreciated by persons skilled in the art, performance of an iteration of the loop includes issuing, decoding and executing instructions that cause functional units within processor system 100 to perform steps 206, 208, 210 and 212 shown in FIG. 2. These steps will now be described.

At step 206, each of a first (X-side) and second (Y-side) M register is initialized to zero. These X-side and Y-side M registers will be used to store the accumulated results of L successive MAC instructions, as will be described below. In the foregoing programming logic, the X-side and Y-side M registers are identified as m0 and m1, respectively.

In the foregoing programming logic, the step of initializing M registers m0 and m1 is programmed using an MZC2SSH instruction as the first MAC instruction. Execution of this instruction causes the contents of M register m0 to be overwritten with the product of the four input samples stored in GPR inx0to3 and the filter coefficient stored in the first half-word of GPR coeff0 and causes the contents of M register m1 to be overwritten with the product of the four input samples stored in GPR iny4to7 and the same filter coefficient. As will be appreciated by persons skilled in the art, overwriting the M registers in this manner is the equivalent of initializing the M registers m0 and m1 to zero prior to executing a MAC instruction.

At step 208, L successive MAC instructions are executed, each MAC instruction using as source operands four successive 16-bit X-side input samples, four successive 16-bit Y-side input samples, and a single 16-bit filter coefficient. As specified by each MAC instruction, the source of the four successive 16-bit X-side input samples is a first 64-bit GPR, the source of the four successive 16-bit Y-side input samples is a second 64-bit GPR, and the source of the single 16-bit filter coefficient is a specified half-word within a third 64-bit GPR. Each MAC instruction specifies as a destination both an X-side and Y-side M register. As shown in the foregoing programming logic, each MAC instruction may also be executed along with an LDL2 instruction that loads four new successive 16-bit X-side input samples and four new successive 16-bit Y-side input samples into the first and second 64-bit GPR registers, respectively, for use in a subsequent iteration of the loop (i.e., to produce the next set of eight output samples).

Thus, for example, the first MAC instruction in the foregoing programming logic specifies inx0to3 as the source of the four successive 16-bit X-side input samples input₀, input₁, input₂ and input₃, specifies iny4to7 as the source of the four successive 16-bit Y-side input samples input₄, input₅, input₆ and input₇, and specifies coeff0.h0 as the source of the single 16-bit filter coefficient coeff₀. The first MAC instruction in the foregoing programming logic specifies as a destination the X-side M register m0 and the Y-side destination register m1.

Responsive to the execution of each MAC instruction, the X-side MAC unit 132x multiplies each of the four X-side input samples specified in the instruction by the filter coefficient specified in the instruction and adds the product to a value stored in a corresponding one of four lanes in the X-side M register. Further responsive to the execution of each MAC instruction, the Y-side MAC unit 132y multiplies each of the four Y-side input samples specified in the instruction by the filter coefficient specified in the instruction and adds the product to a value stored in a corresponding one of four lanes in the Y-side M register. In the foregoing programming logic, the steps of performing L successive MAC instructions are programmed using the MZC2SSH instruction and the multiple MAC2SSH instructions.

As noted above, with each successive MAC instruction, the input is shifted by a single input sample.

At step 210, after the execution of the L successive MAC instructions, the four values stored in the X-side M register are moved to a first GPR and the four values stored in the Y-side M register are moved to a second GPR for output purposes. Each of the eight values is stored in a GPR as a half-word value. These eight values are the eight output samples from the non-decimating FIR filtering function. In the foregoing programming logic, this step is programmed using the MMV2H instructions, wherein the X-side and Y-side M registers are identified as m0 and m1, respectively, and the first and second GPRs are identified as out0 and out1 respectively.

After the eight output samples have been moved to first and second GPRs in accordance with step 210, they are then stored to a data cache/RAM as shown at step 212. In the foregoing program logic, this step is programmed using the STL2 instruction.

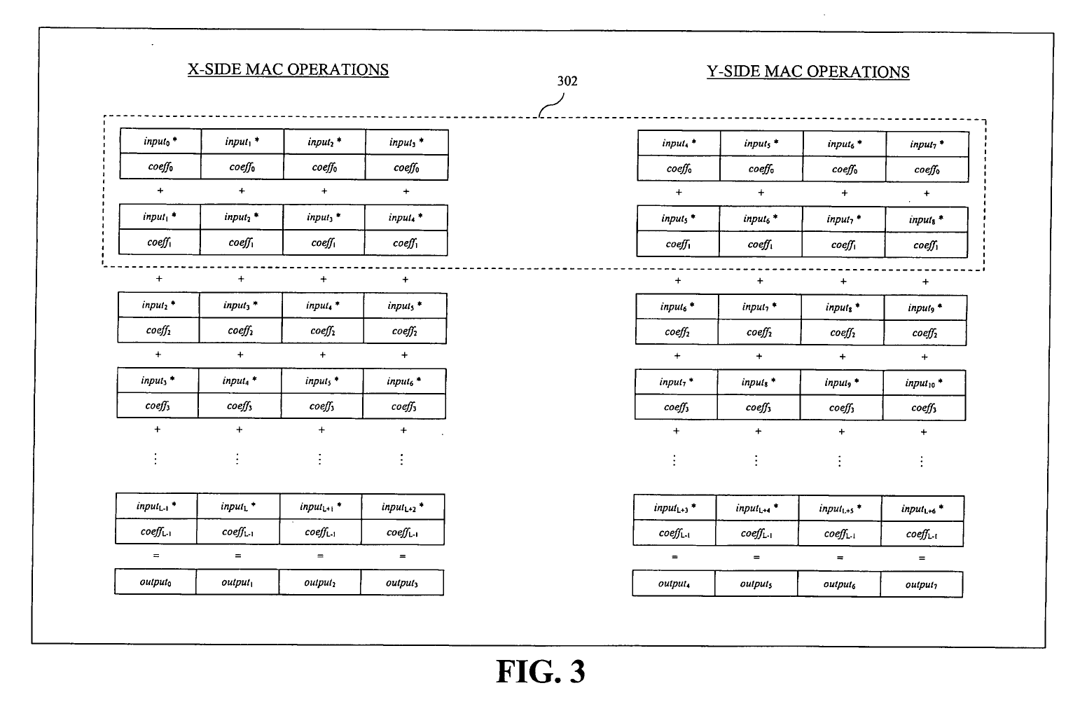

FIG. 3 illustrates the MAC operations that are performed by MAC unit 132x and MAC unit 132y in accordance with step 208 and the foregoing programming logic to generate four output samples per side, for a total of eight output samples. In particular, MAC unit 132x produces the four output samples output₀, output₁, output₂ and output₃, and MAC unit 132y produces the four output samples output₄, output₅, output₆ and output₇. As reflected in FIG. 3, the input samples are shifted by only a single sample for each successive MAC operation, hence there is a significant amount of redundancy in terms of the data being passed in.

Execution of the first two MAC instructions of the foregoing programming code cause the calculations delineated in area 302 of FIG. 3 to be performed. As shown in FIG. 3, execution of the two instructions results in the performance of eight 16-bit multiplications within each of MAC unit 132x and MAC unit 132y. However, as noted in Section 1, above, each MAC unit 132x and 132y includes eight 16-bit multipliers to support 32-bit multiplication operation on two lanes of data. In view of this, it would be desirable to provide a single instruction that, when executed, caused all of the calculations delineated in area 302 of FIG. 3 to be performed, thereby maximizing the use of the 16-bit multipliers within MAC units 132x and 132y and increasing throughput.

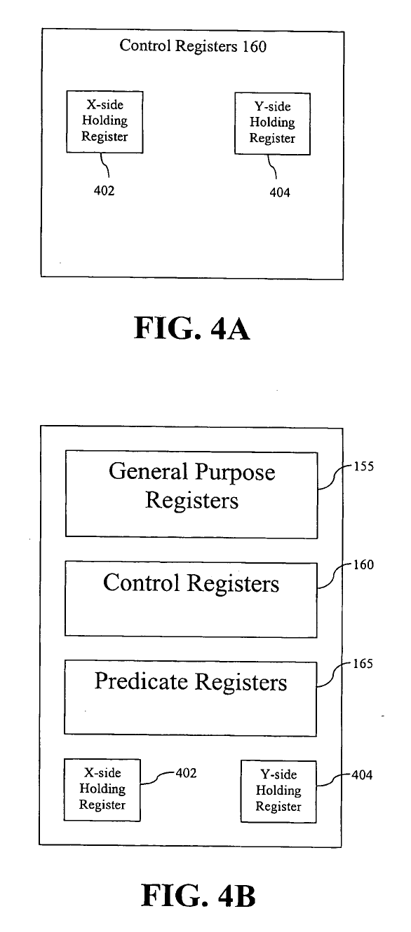

A problem arises, however, because performance of the calculations delineated in area 302 of FIG. 3 requires five 16-bit input samples per SIMD unit, which is more than can be passed in a single 64-bit GPR. To address this, an embodiment of the present invention utilizes two 64-bit holding registers 402 and 404, one for each SIMD unit within processor system 100, to provide the additional input samples necessary for performance of the eight 16-bit multiplication operations on each side of the machine. These holding registers may be implemented as part of control registers 160 of processor system 100, as depicted in FIG. 4A, or as independent registers within the register set of processor system 100, as depicted in FIG. 4B. Persons skilled in the art will readily appreciate that this is simply a matter of design choice.

The manner in which holding registers 402 and 404 are used to implement all of the calculations delineated in area 302 of FIG. 3 via a single instruction will now be described. This approach leverages both the redundancy in the input samples required for each MAC operation and the inclusion of eight 16-bit multipliers on each side of processor system 100 to increase system throughput and accelerate the generation of output samples of the non-decimating FIR filtering function.

In part, the method includes performing the following steps for every eight output samples to be generated. First, the X-side holding register 402 is initialized by loading input samples input₀ to input₃ therein and the Y-side holding register 404 is initialized by loading input samples input₄ to input₇ therein. A series of instructions (generally referred to herein as FIR instructions) is then issued, each of which passes in two further input samples to each SIMD unit. The two further input samples are specified as being in either the first two half-words (h0 and h1) or in the last two half-words (h2 and h3) of a GPR. Each FIR instruction also specifies which half-word lanes of a coefficient register are used for the two stages. In one embodiment, these can be specified as adjacent lanes in ascending order (e.g., h01, h23). However, in an alternate embodiment, the half-word lanes of the coefficient register can also be specified in a descending order (e.g., either h01, h23, h10 or h32). As will be appreciated by persons skilled in the art, this latter embodiment may be useful in the case of a non-decimating FIR filter having symmetric coefficients.

Example programming logic for a loop used in performing this method is as follows:

loop:

| | | |
|---|---|---|
| PUT2FIR | inx0to3/iny4to7 | : LDL2 inx0to3/iny4to7, [input, #0] |
| FIR2ZSSH | m0/m1, inx4to7/iny8to11.h01, coeff0.h01 | |

| FIR2ASSH | m0/m1, inx4to7/iny8to11.h23, coeff0.h23 | : LDL2 inx4to7/iny8to11 [input, #4] |
|---|---|---|
| FIR2ASSH | m0/m1, inx8to11/iny12to15.h01, coeff1.h01 | |
| FIR2ASSH | m0/m1, inx8to11/iny12to15.h23, coeff1.h23 | : LDL2 inx8to11/iny12to15, [input, #8] |
| . . . | | |
| FIR2ASSH | m0/m1, inx<L+2>to<L+5>/iny<L+6>to<L+9>m coeff<m>.h?? : LDL2 . . . | |
| MMV2H | out0/out1, m0/m1, shift | |
| . . . | | |
| STL2 | out0/out1, [output], #16! | |
| SBCCL | loop | : SUBWBS len, len, #1 |

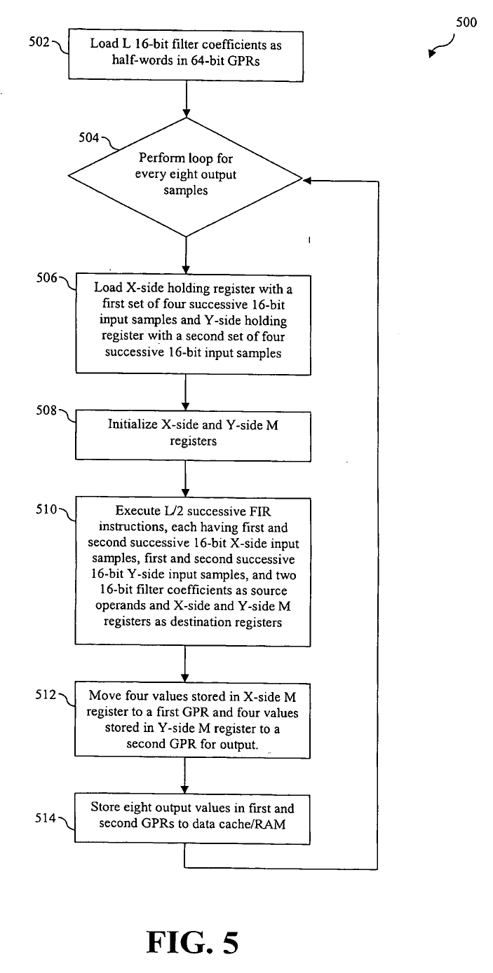

This approach will now be described with reference to flowchart 500 of FIG. 5. As shown in FIG. 5, at step 502, L 16-bit filter coefficients are initially loaded as half-words in GPRs 155, such that four filter coefficients are loaded in a single 64-bit GPR. Thus, for example, four filter coefficients loaded in a register coeff0 may be individually identified as coeff0.h0, coeff0.h1, coeff0.h2 and coeff0.h3. In addition, as noted above, adjacent pairs of filter coefficients loaded in register coeff0 may be identified, for example, as coeff0.h01 and coeff0.h23.

At step 504, an iteration of a loop in accordance with the foregoing programming logic is performed for every eight output samples to be generated. As will be appreciated by persons skilled in the art, performance of an iteration of the loop includes issuing, decoding and executing instructions that cause functional units within processor system 100 to perform steps 506, 508, 510, 512 and 514 as shown in FIG. 5. These steps will now be described.

At step 506, the X-side 64-bit holding register is set with a first set of four successive 16-bit input samples (input₀-input₃) and the Y-side 64-bit holding register is set with a second set of four successive 16-bit input samples (input₄-input₇). In the foregoing programming logic, this step is programmed using the PUT2FIR instruction. As demonstrated by the foregoing programming logic, the PUT2FIR instruction may be executed along with an LDL2 instruction which loads a new set of input samples into registers inx0to3/iny4to7 for a subsequent iteration of the loop.

At step 508, each of a first (X-side) and second (Y-side) M register is initialized to zero. These X-side and Y-side M registers will be used to store the accumulated results of L/2 successive FIR instructions, as will be described below. In the foregoing programming logic, the X-side and Y-side M registers are identified as m0 and m1, respectively, and the step of initializing M registers m0 and m1 is programmed using an FIR2ZSSH instruction as the first FIR instruction. Execution of this instruction causes the contents of M registers m0 and m1 to be overwritten with the results of the FIR instruction. As will be appreciated by persons skilled in the art, overwriting the M registers in this manner is the equivalent of initializing the M registers m0 and m1 to zero prior to executing a FIR instruction.

At step 510, L/2 successive FIR instructions are executed, wherein each FIR instruction specifies as source operands first and second successive 16-bit X-side input samples, first and second successive 16-bit Y-side input samples, and first and second 16-bit filter coefficients. The first and second successive 16-bit X-side input samples are the two input samples immediately following the last input sample in the X-side holding register. The first and second successive 16-bit Y-side input samples are the two input samples immediately following the last input sample in the Y-side holding register. Each FIR instruction also specifies as the destination the X-side and Y-side M registers.

As identified by each FIR instruction, the source of the first and second successive 16-bit X-side input samples are two half-words of a first (X-side) 64-bit GPR that stores four successive X-side input samples, the source of the first and second successive 16-bit Y-side input samples are two half-words of a second (Y-side) 64-bit GPR that stores four successive Y-side input samples, and the source of the first and second 16-bit filter coefficients are two half-words of a GPR that stores four filter coefficients. As shown in the foregoing programming logic, every other FIR instruction is executed along with an LDL2 instruction that loads four new successive 16-bit X-side input samples and four new successive 16-bit Y-side input samples into the first and second GPRs, respectively, for use in a subsequent iteration of the loop (i.e., to produce the next set of eight output samples).

Thus, for example, the first FIR instruction in the foregoing programming logic specifies inx4to7.h01 as the source of the first and second successive 16-bit X-side input samples input₄ and input₅, specifies iny8to11.h01 as the source of the first and second successive 16-bit Y-side input samples input₈ and input₉, and specifies coeff0.h01 as the source of the first and second 16-bit filter coefficient coeff₀ and coeff₁. The first FIR instruction in the foregoing programming logic specifies as a destination the X-side M register m0 and the Y-side destination register m1.

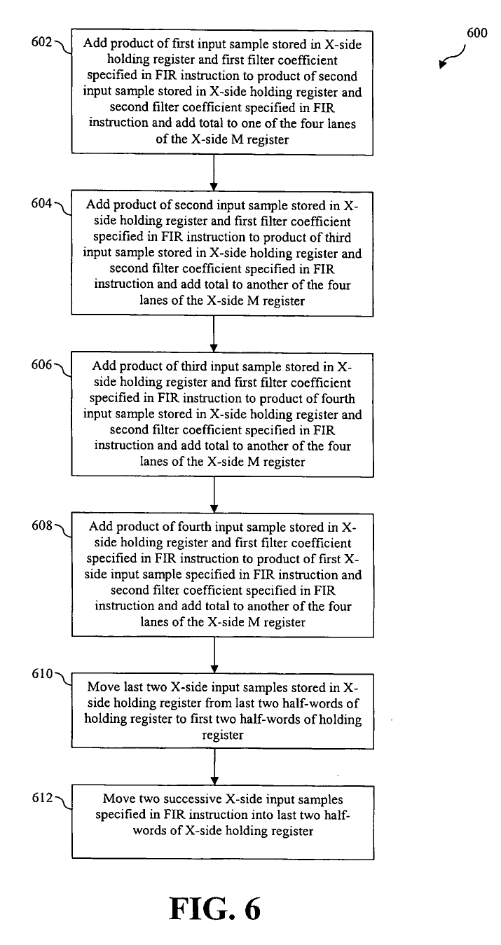

The operations that occur responsive to the execution of each FIR instruction will be described in detail below with reference to FIG. 6. With each successive pair of FIR instructions, the input is shifted by four input samples.

At step 512, after the execution of the L/2 successive FIR instructions, the four values stored in the X-side M register are moved to a first GPR and the four values stored in the Y-side M register are moved to a second GPR for output purposes. Each of the eight values is stored in a GPR as a half-word value. These eight values are the eight output samples from the non-decimating FIR filtering function. In the foregoing programming logic, this step is programmed using the MMV2H instructions, wherein the X-side and Y-side M registers are identified as m0 and m1, respectively, and the first and second GPRs are identified as out0 and out1 respectively.

After the eight output samples have been moved to first and second GPRs in accordance with step 512, they are then stored to a data cache/RAM as shown at step 514. In the foregoing program logic, this step is programmed using the STL2 instruction.

FIG. 6 illustrates operations that occur responsive to the execution of a FIR instruction as described above in reference to FIG. 5 and the foregoing programming logic. FIG. 6 illustrates the operations that occur on the X-side of processor system 100 only. An identical set of operations also occurs on the Y-side of the machine as well, but have not been described here for the sake of brevity. Such operations can be readily understood by simply substituting the term “Y-side” for “X-side” in the following description.

In step 602, the product of the first input sample stored in the X-side holding register and the first filter coefficient specified in the FIR instruction is added to the product of the second input sample stored in the X-side holding register and the second filter coefficient specified in the FIR instruction. The total is then added to one of the four lanes of the X-side M register. For example, with reference to the first FIR instruction in the foregoing programming logic, this step would result in the sum of the product of input₀ and coeff₀ and the product of input₁ and coeff₁ being stored in a first lane of M register m0.

In step 604, the product of the second input sample stored in the X-side holding register and the first filter coefficient specified in the FIR instruction is added to the product of third input sample stored in the X-side holding register and the second filter coefficient specified in the FIR instruction. The total is then added to another of the four lanes of the X-side M register. For example, with reference to the first FIR instruction in the foregoing programming logic, this step would result in the sum of the product of input₁ and coeff₀ and the product of input₂ and coeff₁ being stored in a second lane of M register m0.

In step 606, the product of the third input sample stored in the X-side holding register and the first filter coefficient specified in the FIR instruction is added to the product of the fourth input sample stored in the X-side holding register and the second filter coefficient specified in the FIR instruction. The total is then added to another of the four lanes of the X-side M register. For example, with reference to the first FIR instruction in the foregoing programming logic, this step would result in the sum of the product of input₂ and coeff₀ and the product of input₃ and coeff₁ being stored in a third lane of M register m0.

In step 608, the product of the fourth input sample stored in the X-side holding register and the first filter coefficient specified in the FIR instruction is added to the product of the first X-side input sample specified in the FIR instruction and the second filter coefficient specified in the FIR instruction. The total is then added to another of the four lanes of the X-side M register. For example, with reference to the first FIR instruction in the foregoing programming logic, this step would result in the sum of the product of input₃ and coeff₀ and the product of input₄ and coeff₁ being stored in a fourth lane of M register m0.

In step 610, the last two X-side input samples stored in the X-side holding register are moved from the last two half-words of the X-side holding register to the first two half-words of the X-side holding register. For example, with reference to the first FIR instruction in the foregoing programming example, this step would result in input₂ and input₃ being moved from the last two half-word locations (h23) of the X-side holding register to the first two half-word locations (h01).

In step 612, the two successive X-side input samples specified in the FIR instruction are moved into the last two half-words of the X-side holding register. For example, with reference to the first FIR instruction in the foregoing programming example, this step would result in input₄ and input₅ being moved to the last two half-word locations (h23) of the X-side holding register.

Based on the foregoing, it can be seen that upon completion of the steps of flowchart 600, the operations corresponding to two MAC instructions shown in FIG. 3 have been completed via the processing of a single FIR instruction. For example, after execution of the first FIR instruction in the foregoing programming logic, the M registers m0 and m1 will contain the same results as those obtained from performing the two iterations of MAC operations depicted area 302 of FIG. 3. Furthermore, the shifting of two new input samples into the X-side and Y-side holding register ensure that the proper operands are available for a subsequent FIR operation.

### 4. Example Instructions in Accordance with an Embodiment of the Present Invention

Example instructions that may be used to implement an embodiment of the present invention are described below. However, these examples are not intended to be limiting and persons skilled in the art will readily appreciate that other instructions and instruction formats may be used to practice the present invention.

| a. | PUTFIR |
|---|---|
| Format: | |
| | PUTFIR input |
| Effect: | |
| | FIR_hold[63:0] = input[63:0]; |
| Description: | |
| | This instruction sets the FIR holding register. |
| b. | GETFIR |
| Format: | |
| | GETFIR output |
| Effect: | |
| | output[63:0] = FIR_hold[63:0]; |
| Description: | |
| | This instruction reads the FIR holding register for that side, for |
| context-switching/verification purposes only. | |
| c. | FIRxxxH |

Format:
FIR<mode>S<signed>H Mreg, input.<input_field>, coeff.<coeff.field>

where:
mode = Z, A, N or D;
signed = S or U;
input_field = h01 or h23;
coeff_field = h01, h23, h10 or h32

Effect:

Let input_field = h<i0><i1> and coeff_field = h<c0><c1>.
Then:

prod.h0<31:0> = FIR_hold.h0 * coeff.h<c0> + FIR_hold.h1 * coeff.h<c1>;
prod.h1<31:0> = FIR_hold.h1 * coeff.h<c0> + FIR_hold.h2 * coeff.h<c1>;
prod.h2<31:0> = FIR_hold.h2 * coeff.h<c0> + FIR_hold.h3 * coeff.h<c1>;
prod.h3<31:0> = FIR_hold.h3 * coeff.h<c0> + input.h<i0> * coeff.h<c1>;
FIR_hold_new.h0 = FIR_hold.h2;
FIR_hold_new.h1 = FIR_hold.h3
FIR_hold_new.h2 = input.h<i0>;
FIR_hold_new.h3 = input.h<i1>;
switch(mode)
{

case ‘Z’: Mreg = prod;
case ‘A’: Mreg += prod;
case ‘N’: Mreg = −prod;
case ‘D’: Mreg −= prod;

}
Description:

This instruction performs 2 stages of a non-decimating FIR filter.

### 5. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for performing finite impulse response (FIR) filtering operations in a processor system, comprising:
(a) storing a first plurality of successive input samples in a holding register responsive to issuance of a first instruction; and
(b) responsive to issuance of a second instruction, the second instruction specifying a second plurality of successive input samples as source operands, performing calculations based on the first plurality of successive input samples and at least one of the second plurality of input samples to produce values used to generate one or more output samples of a FIR filter.

2. The method of claim 1, wherein the FIR filter is a non-decimating FIR filter.

3. The method of claim 1 wherein step (b) comprises multiplying each of the first plurality of successive input samples by one or more filter coefficients and multiplying at least one of the second plurality of successive input samples by a filter coefficient.

4. The method of claim 3, further comprising:
initializing each of a plurality of final output accumulators to zero prior to step (b); and
wherein step (b) further comprises adding the result of each multiplication of input samples and filter coefficients to a respective one of the plurality of final output accumulators.

5. The method of claim 3, wherein each multiplication is executed on a different multiplier.

6. The method of claim 5, wherein each multiplication is executed substantially in parallel on a different multiplier.

7. The method of claim 1, wherein step (a) comprises storing four successive input samples in the holding register responsive to issuance of the first instruction, wherein the second instruction specifies two successive input samples as source operands, and wherein step (b) comprises:
(i) adding the product of a first input sample in the holding register and a first filter coefficient to the product of a second input sample in the holding register and a second filter coefficient to produce a first sum used to calculate a first output sample;
(ii) adding the product of the second input sample in the holding register and the first filter coefficient to the product of a third input sample in the holding register and the second filter coefficient to produce a second sum used to calculate a second output sample;
(iii) adding the product of the third input sample in the holding register and the first filter coefficient to the product of a fourth input sample in the holding register and the second filter coefficient to produce a third sum used to calculate a third output sample; and
(iv) adding the product of the fourth input sample in the holding register and the first filter coefficient to the product of a first input sample specified by the second instruction and the second filter coefficient to produce a fourth sum used to calculate a fourth output sample.

8. The method of claim 7, wherein the second instruction specifies the first and second filter coefficients as source operands.

9. The method of claim 7, wherein step (b) further comprises:
copying the third and fourth input samples in the holding register to the respective locations of the first and second input samples within the holding register; and
copying the first and second input samples specified by the second instruction to the former respective locations of the third and fourth input samples within the holding register.

10. The method of claim 7, further comprising:
initializing each of four final output accumulators to zero prior to step (b);
and wherein step (b) further comprises:
adding the first sum to a first of the four final output accumulators to calculate the first output sample;
adding the second sum to a second of the four final output accumulators to calculate the second output sample;
adding the third sum to a third of the four final output accumulators to calculate the third output sample; and
adding the fourth sum to a fourth of the four final output accumulators to calculate the fourth output sample.

11. A processor system, comprising:
a holding register;
an instruction decode unit; and
an execution unit connected to the holding register and the instruction decode unit;
wherein the execution unit is adapted to store a first plurality of successive input samples in the holding register responsive to issuance of a first instruction from the instruction decode unit; and
wherein the execution unit is adapted to perform calculations based on the first plurality of successive input samples stored in the holding register and at least one of a second plurality of input samples to produce values used to generate one or more output samples of a FIR filter responsive to issuance of a second instruction from the instruction decode unit, wherein the second instruction specifies the second plurality of successive input samples as source operands.

12. The processor system of claim 11, wherein the FIR filter is a non-decimating FIR filter.

13. The processor system of claim 11, wherein the execution unit is adapted to multiply each of the first plurality of successive input samples by one or more filter coefficients and to multiply at least one of the second plurality of successive input samples by a filter coefficient.

14. The processor system of claim 13, wherein the execution unit is further adapted to initialize each of a plurality of final output accumulators to zero and to add the result of each multiplication of input samples and filter coefficients to a respective one of the plurality of final output accumulators.

15. The processor system of claim 13, wherein the execution unit comprises a plurality of multipliers, each of which is adapted to perform a different one of the multiplications.

16. The processor system of claim 15, wherein each of the plurality of multipliers is adapted to perform a different one of the multiplications substantially in parallel with the others multipliers.

17. The processor system of claim 11, wherein the execution unit is adapted to store four successive input samples in the holding register responsive to issuance of the first instruction, wherein the second instruction specifies two successive input samples as source operands, and wherein the execution unit is adapted to, responsive to issuance of the second instruction:
(i) add the product of a first input sample in the holding register and a first filter coefficient to the product of a second input sample in the holding register and a second filter coefficient to produce a first sum used to calculate a first output sample;
(ii) add the product of the second input sample in the holding register and the first filter coefficient to the product of a third input sample in the holding register and the second filter coefficient to produce a second sum used to calculate a second output sample;
(iii) add the product of the third input sample in the holding register and the first filter coefficient to the product of a fourth input sample in the holding register and the second filter coefficient to produce a third sum used to calculate a third output sample; and
(iv) add the product of the fourth input sample in the holding register and the first filter coefficient to the product of a first input sample specified by the second instruction and the second filter coefficient to produce a fourth sum used to calculate a fourth output sample.

18. The processor system of claim 17, wherein the second instruction specifies the first and second filter coefficients as source operands.

19. The processor system of claim 17, wherein the execution unit is further adapted to, responsive to issuance of the second instruction:
copy the third and fourth input samples in the holding register to the respective locations of the first and second input samples within the holding register; and
copy the first and second input samples specified by the second instruction to the former respective locations of the third and fourth input samples within the holding register.

20. The processor system of claim 17, wherein the execution unit is further adapted to initialize each of four final output accumulators to zero and to:
add the first sum to a first of the four final output accumulators to calculate the first output sample;
add the second sum to a second of the four final output accumulators to calculate the second output sample;
add the third sum to a third of the four final output accumulators to calculate the third output sample; and
add the fourth sum to a fourth of the four final output accumulators to calculate the fourth output sample.
